(19) United States
(12) Patent Application Publication
(10) Pub. No.: US 2015/0287141 A1
(43) Pub. Date: Oct. 8, 2015

(54) Portfolio optimization by the detection and control of the predictive horizon of included investments.

(71) Applicant: Edgar Parker, JR., (US)

(72) Inventor: Edgar Parker, JR., Bayside, NY (US)

(21) Appl. No.: 14/244,872

(22) Filed: Apr. 3, 2014

(51) Int. Cl. G06Q 40/06

(52) U.S. Cl. CPC G06Q 40/06

(57) ABSTRACT

An investment portfolio management method for creating or rebalancing an investor's securities portfolio based on the predictive horizon of included investments. Individual investments are chosen for inclusion, exclusion, or rebalancing based on the predictive time horizon of the individual investments and the portfolio. Existing portfolios can be optimized using this technique individually or in conjunction with other techniques such as Modern Portfolio Theory (MPT). Additionally this technique can be utilized to completely and independently construct a minimally or mixed chaotic portfolio without also using other techniques. Additionally the individual investments and/or the portfolio as a whole are tested to determine the predictive time horizon in the individual investments and the portfolio. Individual investments are chosen for inclusion, exclusion, or rebalancing based on the predictive time horizon of the individual investments and the portfolio. Existing portfolios can be optimized using this technique individually or in conjunction with other techniques such as Modern Portfolio Theory (MPT).

### RELATED APPLICATIONS

The present application claims the benefit under 35 U.S.C. .sctn.119(e) of U.S. Provisional Application Ser. No. 61/808,612, filed Apr. 4, 2013, entitled “Portfolio optimization by the detection and control of the degree of chaos, chaotic intermittency, and the predictive horizon of included investments,” which is incorporated herein by reference in its entirety.

### SPECIFICATION

An investment portfolio management method for creating or rebalancing an investor's securities portfolio based on the predictive horizon of included investments. Individual investments are chosen for inclusion, exclusion, or rebalancing based on the predictive time horizon of the individual investments and the portfolio. Existing portfolios can be optimized using this technique individually or in conjunction with other techniques such as Modern Portfolio Theory (MPT). Additionally this technique can be utilized to completely and independently construct a minimally or mixed chaotic portfolio without also using other techniques. Additionally the individual investments and/or the portfolio as a whole are tested to determine the predictive time horizon in the individual investments and the portfolio. Individual investments are chosen for inclusion, exclusion, or rebalancing based on the predictive time horizon of the individual investments and the portfolio. Existing portfolios can be optimized using this technique individually or in conjunction with other techniques such as Modern Portfolio Theory (MPT).

Tests of Chaos, Intermittency and the predictive horizon used in the Steps that follow:

1. PRST (Estimating Fractal dimension, Largest Lyapunov Exponent, and the Kolmogorov Entropy) as described by (Rosenstein et al. 1993)

### 2. Correlation Dimension

3. Grassberger-Procaccia algorithm (GPA) for dimension and entropy
4. BDS Tests as described by (Brock et al. 1993)
5. Kolmogorov entropy

### 6. Barahona/Poon

7. Nychka, Ellner, Gallant, and McCaffrey (1992) dominant Lyapunov exponent estimator.
8. Visualization of system dynamics using phasegrams by Christian T. Herbst, Hanspeter Herzel, Jan G. Svec, Megan T. Wyman and W. Tecumseh Fitch (May 2013).
9. Reciprocal of Lyapunov Exponent, and the reciprocal of Kolmogorov Entropy to determine predictive horizon.

### DETAILED DESCRIPTION OF THE EXEMPLARY EMBODIMENTS

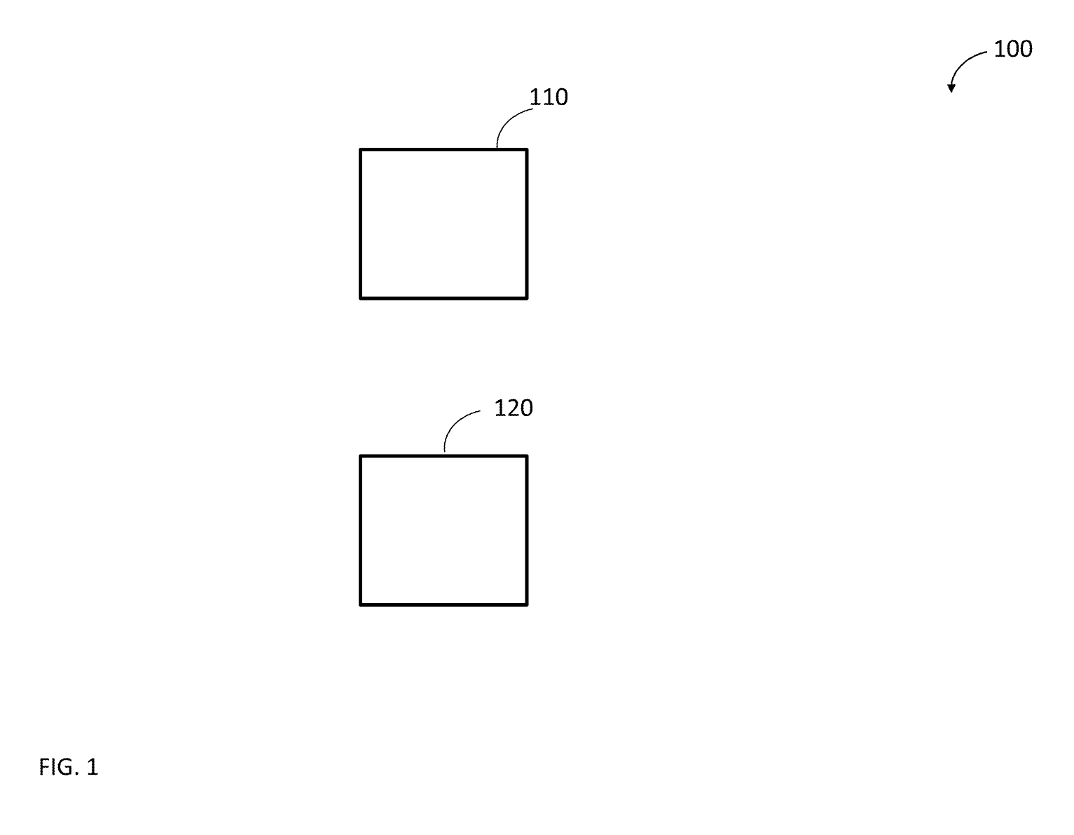

FIG. 1 depicts an operating environment 100 in accordance with an exemplary embodiment of the present invention. Referring to FIG. 1, a computer 110 or server 120 hosts software used to determine the predictive time horizon of securities for inclusion or exclusion in a portfolio.

Background:

Portfolio optimization by the detection and control of the predictive horizon of included investments.

The definition of the Lyapunov time is (LT) tλ=a(1/λ) (where a is a constant) and the reciprocal of Kolmogorov entropy 1/K. (LT) and 1/K define the “time scale of a rational and effective forecast” (He 2011, p 245). In a chaotically evolving system beyond this limit the initial measurement errors (or the limit of initial precision) grow to dominate estimates of the future state of the system. “Beyond this horizon, several trajectories from nearby initial conditions separated by the initial precision s(initial) will disperse in the phase space” (Gaspard 2000, p 3). Beyond this point (>(LT) tλ and a(1/λ) is where true classical diffusion occurs. This diffusion (when α=1, in <x2≈tα) is what is assumed in many theories in modern finance such as portfolio theory and the Black-Scholes model.

The securities or investments selected for a portfolio should first be chaotic or have a positive Lyapunov exponent (∞>>λaverage>0). Additionally, the securities or investments should have a Lyapunov time and/or a reciprocal of Kolmogorov entropy, which are both less than the Portfolio's time horizon. Finally intermittently chaotic securities are also excluded. These conditions are the basis of Normal Gaussian Diffusion which is often assumed in modem financial theory.
Portfolio Time Horizon>tλ and 1/K for selected securities
∞>>λaverage>0 and implies α=1 in <x2>≈tα
These conditions are indicative of Normal Gaussian Diffusion assumed in standard Portfolio Theory

Background Information:

Relative Channel Capacity and Realized Diffusion with an application to Price Behavior (From Determinism to Quantum Ignorance)

Executive Summary:

I make 4 modifications to traditional financial Brownian motion metaphor to better fit financial reality:

Relative Channel Capacity and Physical Quantum Uncertainty together diffusive behavior

Relative Channel Capacity varies across securities, market participants, and time

Microscopic chaotic diffusion is the mechanism by which Relative Channel Capacity and

Physical Quantum Uncertainty generate the various states of security diffusion

There is a global/market component to market information

These four assumptions lead to behavior that better fits observed financial reality:

Non-normality

Leptokurtosis

Correlation Changes

Additionally this model explains:

The limits of prediction and the appropriateness of Gaussian assumptions

The underlying origin of the “ad hoc” Mixed Distribution Hypothesis used in stochastic volatility models

The apparent “paradox” of chaos and comovement/correlation

The fractal nature of prices (Self Affinity and similarity at different time scales)

The relationship between “passively” and “actively” driven Brownian phenomena (ex. Brownian motion of a diffusing particle in a solution versus cell migration)

Using the new model I propose a method to optimize portfolios by the detection and control of the degree of chaos, chaotic intermittency, and the predictive horizon of included investments

Relative Channel Capacity and Realized Diffusion with an application to Price Behavior (From Determinism to Quantum Ignorance)

Abstract:

There is realistically an infinite amount of information around us bubbling up from the Plank scale quantum foam. Agents or decision makers can only detect and process a minute subset of this information at various time scales. It is the interplay between the information detection rate and information processing rate at various timescales that determine the diffusive properties of information and other objects processed or acted upon by a decision maker. “I am now studying Boltzmann's Gastheorie once again. Everything is very fine, but too little value is placed on the comparison with reality.” Einstein (1901) while completing his theories on Brownian motion.

Over the years both the relatively new and intimately related fields of chaotic mathematics and fractal geometry have offered tantalizing hints of possible applications in finance. By now there have been a plethora of theories, books, articles, and lectures on many fascinating aspects of these areas of research. There are countless graphs and statistical analysis that lead easily to the realization that indeed some of these models “behave like our markets”. But a valid criticism remains after all these years. If these theories have any relevance in finance where are the immediate financial applications?

Additionally significant advances in the field of information theory have been made in the last few decades. Since its birth in Shannon's seminal 1948 paper information theory has reshaped our world from the early applications in telephony to the internet. Our everyday information filled lives would not be possible without Shannon's insights.

What follows (utilizing information theory and new ideas from physics and mathematics) is a new construction from a fundamental level of a theory describing the behavior of securities, and the exposition of a proposed immediate application to portfolio optimization. The ideas presented here are also more generally applicable to other types of diffusive behavior. Information Theory was almost singlehandedly born with the 1948 publication of Claude Shannon's paper “A Mathematical Theory of Communication”. In it he spelled out what is now often called the Fundamental Theorem of Information Theory. The Fundamental Theorem simply states “that it is possible to transmit information through a noisy channel at any rate less than channel capacity with an arbitrarily small probability of error.” (Robert Ash 1965, p. 63). In what follows I construct a model of diffusive behavior based upon information theory that incorporates elements of modern chaotic and fractal mathematics. The motivation of this construction is to provide a new explanation of price behavior and its apparent anomalies. Additionally it is hoped that this new perspective will help shed light on possible new practical applications. These new applications and tools result from the linkages between statistical mechanics and dynamical systems theory made possible by the information theory architecture and the resulting chaotic substructure.

Traditional Brownian motion models the trajectory of a particle in a uniformly warm medium. This model was adopted by Bachelier (1900) to explain price movements. Several assumptions underlie this model. These include price change independence, statistical stationarity of price changes, and that the price changes are normally distributed. However, a great deal of research throws into question the validity of these assumptions. For a summary of the assumption violations see Mandelbrot (2004).

I propose adding four new assumptions to the standard Brownian motion metaphor that has been used as a foundation of modern financial theory. These include that a source of the diffusive behavior is relative channel capacity, microscopic chaotic diffusion is the mechanism by which relative channel capacity generates the various states of diffusion, information is heterogeneous (across securities and time), and that there is a global (market) component to information.

Decision Maker: Information Capture and Processing

A decision maker has a detection system that captures information from the outside world. It is assumed that there an infinite number of different streams of information capacity rates. The decision maker captures information from the highest capacity rate stream that the detection system can handle. This rate of the capture is the information realizations channel capacity Cr. The captured information arrives at the information processing unit at rate Cr. The processing unit has a channel capability of Cp. The processing unit includes both the internal processing elements and connections between decision maker and the outside world. The decision maker acts upon the outside world using the results of the processing unit. The relationship between the rates Cr and Cp and the level of Cr relative to the timescale determine the diffusive behavior of prices, objects and information interpreted and acted upon by a decision maker.

Information from Quantum Foam to Realized/Received Information to processed/actioned information

There is a realistically infinite amount of information available in the universe. Even at unimaginably minute scales all the way down to Planks length information exists. However because of the limitations of our senses and processing capabilities only a small amount of this information is realistically relevant in our world.

A smaller subset of this realistically relevant information is important for security price behavior. This subset includes information that we must be able to first realize as information relevant to prices. Once this information is realized then ideas, theories about how it should impact security prices can be developed and acted upon. The rate at which information is realized and the rate at which it is processed will be deemed the Realization and Processing rates respectively. The relationship between the realization rate and processing rates determines the diffusive behavior of securities at relevant time scales.

Different markets have different relevant time scales at which to measure the realization and processing rates of information. Additionally information that is important at some time scales is not relevant at other time scales. For instance high frequency automated computer trading information is not relevant at scales of days, weeks or years. Similarly a typical mutual fund portfolio manager will not be interested or even be aware of second to second changes in the prices of the securities in her portfolio. This is a source of self similar and self affine scaling. (Albrecht et al 2012) examine the origin of the probabilities that dictate our daily life.

These rules with which we are so familiar include the results of coin flipping to the movement of particles in a gas. The authors argue that all the examples of probability in action that we see actually have their origins in the quantum fluctuations in the microscopic world. They illustrate this with examples based upon collisions between idealized billiards. Their calculations show how initial quantum uncertainty eventually comes to dominate the behavior of any system that can be modeled in a similar fashion. They provide results from such diverse examples as nitrogen at standard temperature and pressure, to billiards, to a bumper car ride.

Assuming the (Albrecht et al 2012) hypothesis is correct then the uncertainties and probabilities seen in the everyday physical world have their origins from uncertainty at the most fundamental level. Chaotic propagation takes this initial uncertainty and amplifies it exponentially until the initial minute uncertainty dominates outcomes in our larger scale world. This analysis sets the lower possible limits on the origins and expression of diffusion in physical systems.

Decision Maker's Introduction of Uncertainty

In the analysis that follows an additional route to diffusion is theorized that exists whenever a decision maker utilizes, processes, and acts upon information. Both routes (purely physical quantum based and the information processing based) determine the ultimate diffusive properties of a system involving a decision maker. The decision maker's resolution (or error minimization) is theoretically limited to quantum uncertainty in the extreme limit. However both the decision makers resolution and processing of that information are likely to have errors well beyond the limits implied by pure quantum uncertainty. (While (Albrecht et al 2012) demonstrated how quantum uncertainty is the primary source of probabilities in physical systems in our world, the introduction of a decision maker with imperfect modeling of that physical world down to the quantum level and at higher levels is likely to create a larger uncertainty that subsumes the propagated quantum uncertainty.)

These errors introduced by the decision maker resolution and processing limits are chaotically and exponentially propagated in the same manner as quantum uncertainty (In a normally diffusing system). This growing uncertainty comes to dominate the evolution of the system involving a decision maker.

Origins of uncertainty: Resolution limits, additive noise, and channel capacity breakdown

1. Initial uncertainty or resolution limit which may be propagated chaotically. (Ultimate limit in terms of resolution is quantum uncertainty)

2. Additive Noise which once introduced may be propagated chaotically in method similar to 1.

A. Introduced from outside environment (Such as thunderstorm static affecting radio transmission)

B. Introduced by Channel Capacity breakdown Cr>Cp, leading to the addition of noise in the signal.

The 3 Sources of Diffusion
I. Physical limits set by the laws of physics. Ultimate limit is determined by quantum uncertainty which can find expression in our large scale world
II. II. Decision Maker's perception or “resolution” limit which can reach but not exceed limit set in part I.
III. III. Relative Channel Capacity which as a limit determined by the perception limit in part II.

Despite important differences between the worlds of particles in physics and that of prices in finance some characteristics are shared in common. Our knowledge of both worlds is limited by the practical and theoretical precision of our measurements. In the physical world uncertainty stems from limitations in the measurement and manipulation of matter. While in the world of prices uncertainty ultimately arises from our limitations in the measurement, manipulation, and communication of information. In a very real sense these limitations can be seen as the same part of the same problem.

Homing Missile Analogy and Cr, Cp

To help introduce the ideas presented in this paper, an analogy based on a homing missile will be utilized. The homing missile will use a tracking device at its nose to zero in on its target. The information from this missile tracking system must be analyzed by a processing unit and then the results of that analysis are used to modify the missile's trajectory as needed. The tracking device has a certain frame rate or rate of image capture of its target per second, and the processing unit similarly has a rate at which it can receive and process that tracking unit's output.

If the frame rate is too low no amount of processing capability will allow the missile to impact an evading target. But a sufficient frame rate must be supported by an accurate and rapid processing unit.

The first limitation on the ability of the missile to successfully impact the target is the capture rate of the tracking device. The second limitation is the processing unit's rate of analysis (and accurate action upon that analysis which for simplicity is assumed to be part of the analysis unit's function). If the capture rate is too low then even the best processing unit will not allow the missile to impact its target. Similarly even the best image capture system will not be able to compensate for an inferior processing unit.

The accuracy of the missile will be measured by the distance the missile's impact is from the intended target. The goal of the missile designer is to reduce the distance between the missile impact point and the distance to the target. This minimum distance will be bounded by two quantities. The first is the image capture per second (Channel Capacity Cr) of the tracking device. Given the first, the second quantity affecting target accuracy is the information processing rate per second (Channel Capacity Cp). The processing unit uses the captured image information to compute an intercept course (and act upon that computed intercept course). The interplay of these quantities will set the limit of the potential lower bound of the variance from target for the missile impact. In summation the image capture per second (Channel Capacity Cr) sets the possible lower limit on distance from target at impact/explosion, while accurate processing rate per second (Channel Capacity Cp) determines how close the missile will actually come to that possible lower limit.

Assume the engineer has designed a missile that hits the target exactly 100% of the time.

The engineer may want to know how changes in the image capture vs the processing unit may affect performance. The engineer may lower Cr until tested missiles begin to impact larger and larger distances from the target. A similar exercise with Cp will result in a similar spreading of impacts distributed in a circle of growing radius around the intended target.

A deeper analysis will reveal there is a minimum Cr and a minimum Cp that allow for an given level of desired error in terms of distance from desired impacts. Similarly an image capture unit of infinite capacity will have an associated processing unit whose channel capacity (Cp) just allows desired impact of the target. If the Cp falls below this critical, level repeated trials of the missile will result in impacts spread around the location of the target. This dependence on the decision maker's relative channel capacity Cr/Cp leads to the concept of realized diffusion.

Realized Diffusion by relative Channel Capacity

On a given timescale the realized diffusion of information or objects in a process involving a decision maker is determined by the decision maker's relative channel capacity. This relative channel capacity is defined as the difference between channel capacities of the information realization and processing systems of the decision maker. This difference determines the relative degree of diffusion of the information or object acted upon by the decision maker.

Chimps and Humans Cr vs Cp

Another example may help better describe the concepts of Cr and Cp. In a surprising result (Inoue and Matsuzawa 2007 p. 2) showed that “young chimpanzees have an extraordinary working memory capable for numerical recollection better than that of human adults.” If this is the case then why didn't chimps developed calculus well before us. The obvious reason is despite their superior ability to rapidly and accurately recognize numbers when compared to humans, chimps ability to accurately process that recognized information is restricted to a very elementary level. Effectively the authors demonstrated that the young chimp's Relative Channel Capacity was greater than that of humans for this simple skill test. But fortunately for us humans possess a much greater Relative Channel Capacity in tests involved higher level processing.

Links between Information Theory and Dynamical Systems Theory In Holliday et al 2 (2005, 2006) the authors explicitly derived the mathematical connections between Shannon Entropy and Lyapunov exponents and dynamical systems theory.

Among their results they found for the class of systems examined:

H(Y|X)=−λ(Y|X);

Where H(Y|X) represents the rate of gain of information about Y given X (or equivalently the reduction in the randomness of Y given X measured in bits/sec).

As the authors state (Holliday et 2005) p. 1763 their results now open the door to the application to information theory other long established methods from other disciplines such as physics. Holliday 2005 et al p. 1763 “Finally, we should note that this connection between Lyapunov exponents and Information Theory is just a first step. We now have access to a wide range of tools from statistical mechanics that can be applied to problems in Information Theory and hidden Markov models.

Relative Channel Capacity and the Conditional Lyapunov exponent λ=1imt→∞(1/t)(log(δXt/δXo))=1imt→∞(1/t)(log(εf/ε/i)=Lyapunov Exponent (LE) which measures the rate that an initial measurement error ci (or perturbation from Xo designated as δXo grows). If the LE is positive this rate of divergence or error growth is exponential.

Starting with Shannon's discrete channel result (Shannon 1948 p. 3):

C=1imt→∞logN(t)/t; Where

C=Channel capacity and N(t)=number of sequences of duration t.

Add the variables

Cr=Channel Capacity of Information Realization System

Cp=Channel Capacity of Information Processing System

Nr(t)=number of R sequences of duration t (Determined by the rules of the codebook: symbols, words, allowed structure).

Np(t)=number of P sequences of duration t (Determined by the rules of the codebook: symbols, words, allowed structure).

Cr=1imt→∞logNr(t)/t (Shannon 1948 p. 3)

Cp=1imt→∞logNp(t)/t

Cr−Cp=1imt→∞logNr(t)/t−1imt→∞logNp(t)/t

Cr−Cp=1imt→∞(log(Nr(t)/Np(t)))/t=λ(Np(t)|Nr(t))

Cr−Cp=λ(Np(t)|Nr(t)=λr

This equation relates the difference in the information realization and processing rate to the conditional Lyapunov Exponent.

Cr−Cp=λ(Nr(t)|Np(t))>0 The processing channel capacity is less than the realization rate which results in the loss of information and since λ(Nr(t)|Np(t)>0, the divergence in information will be exponential and chaotic.

Cr−Cp=λ(Nr(t)|Np(t))≦0 The processing channel capacity is greater than or equal to the realization rate which results in no loss of information and since λ(Nr(t)|Np(t)<0.

λr represents the Realized Lyapunov exponent

λr=(1/T)(ln(εf/εi)

A message is received from the universe at rate Cr with codebook composed of Nr codewords. Assume Nr is optimal number of codewords of optimal length (Generalizes to suboptimal—i.e. diffusion around originally diffused model or coding). The decision maker needs a processing system with (upper bound)>Np (# of codewords)>(lower bound) in order to achieve reliable communication (No loss of information). Also the decision maker must have channel capacity Cp≧Cr (codewords per second) or else information is lost.

Cr is a communication from the internal process of the decision maker to the outside world. This communication results in actions upon information and matter. The measurement of actual result to the desired effect on information and/or matter is the error rate of the communication.

Sphere packing and Information Theory and Codeword Upper and Lower Bounds (Cohn 2010 p. 2421) discusses how the issue of the optimal packing of spheres relates to information theory. One of the basic questions is how to fill a space with non-overlapping spheres of similar size. Cohn uses the example of a transmitter at the center of a sphere of radius r. Inside this sphere are a number of smaller balls. Each of these balls represents a distinct frequency (or codeword or part of the communication vocabulary). The noise level of the transmission is denoted by ε. For a signal |X-X_{,,}|<ε so that if two balls of radius ε do not overlap the received signal X″ will not be confused with another signal. For efficient communication one needs to maximize the number of distinct non-overlapping balls of radius ε that fit in the larger sphere of transmission. In the limit r/ε→∞. Optimally packed spheres will touch tangentially but not cross borders. Thus the sphere-packing argument only yields the maximum number of codewords (which reside at the center of the r=ε balls) that can be used to ensure efficient communication.

Note that larger numbers of longer codewords results in lower chances of error in the transmission of a signal. However as the codebook(encoded alphabet) gets larger this results in more bits/second being sent to communicate a given message. At some point an increasingly larger codebook will approach the Shannon Limit. For the purposes of this paper the important concept is that the maximum non-overlapping density of the packed spheres will result in error free communication {(upper bound)>Np (# of codewords)>(lower bound)}.

Lorentz Gas Compression Equivalence to Optimal Codeword Number

In any region of space containing an idealized Lorentz gas, as the gas is compressed the uncertainty of movement of a Brownian particle goes to zero. The path of the particle will become known with certainty in the limit of the idealized gas particles touching tangentially. As distance between the gas particles is gradually increased the uncertainty and information loss also grows at an increasing rate.

Additive White Gaussian Noise http://en.wikipedia.org/wiki/Additive_white_Gaussian_noise

The number of codewords is equal to or less than the volume of the y-sphere Vy to that of a noise sphere Vw for reliable communication. (p. 530 Tse and P. Viswanath 2005)

Vy/Vw=[(N(P+ζ2))½]N/[(Nζ2)½]N=(½)log(1+P/ζ2)

The number of codewords is equal to or less than the volume of the y-sphere Vy to that of a noise sphere Vw for reliable communication. (p. 530 Tse and P. Viswanath 2005) The lower bound on the codeword length in terms of R bits per symbol time is given by R=log|ξ|/=log(1/p)/N−logN/N<(½)log(1+P/ξ2) (p. 530 Tse and P. Viswanath 2005) Anomalous to normal diffusion (Normal diffusion, subdiffusion, and superdiffusion) From (Klages 2009 p. 31-32) the equation below describes the mean square displacement of a group of particles over time. Where if α=1 then K=2D is the generalized diffusion coefficient in the case of normal diffusion.

K:=1im<x2>/nα

n→∞

furthermore from the relation

<x2≈nα, (n→∞)

If α<1 there exists a state of subdiffusion,

If α=1 there exists a state of normal diffusion,

If α>1 there exists a state of superdiffusion.

Diffusive Continuum (By Channel Capacity at a given time scale Δt)

Cp≧Cr≧RT, λ≦0, α<1, Var≈0 (RT is resolution needed for optimal particle solution, super stable orbits assuming perfect information processing)

Cp≧Cr≦SubD<RT, λ>0, α<1, Var>0 (Partial trapping, unstable periodic orbits)

Cp≦Cr≧Diff<SubD<RT, λ>0 at maximum, α=1, Var>0 (Normal assumptions)

Cp≧Cr≦SupD<Diff<SubD<RT, λ→0, α>1, Var→∞

### Where;

Cp=Information Processing Channel Capacity (Assumes other market participants have perfect information)
Cr=rate of capture of information, or realization information channel capacity
SubD=Subdiffusive behavior level

### Diff=Normal Diffusion

SupD=Super Diffusive level

### λ=Lyapunov Exponent

α=Diffusive exponent
Var=variance of price

Restating Diffusive Continuum in terms of Mean Square Displacement (By Channel Capacity at a given time scale Δt)

<x2>≈tα, Generalized Mean Square Displacement where α=1 in normal diffusion

Set α=Cr/Cp

<x2>∞tCr/Cp

If Cr/Cp<1 there exists a state of subdiffusion,

If Cr/Cp≧1 there exists a state of normal diffusion,

If Cr/Cp>>1 there exists a state of superdiffusion.

Timescales in the Traditional Model (Relationship between deterministic and stochastic behavior)

The standard discrete equation for geometric Brownian motion is given below:

dX(t)/X(t)=αdt+ζdZ(t), where α and ζ are the instantaneous mean and variance respectively p. 656 MacDonald. To examine the impact of timescale changes on Brownian motion the discrete version is presented below:

X(t+h)−X(t)=αX(t)h+ζ+X(t)Y(t)✓h,

αX(t)h can be viewed as the deterministic component and ζ(t)Y(t)✓h as the random component of the changes in X (p. 656 MacDonald).

In the below MacDonald illustrates the change in character of the movements of X as the time scale examined changes (Assume α, ζ=10%) . At smaller time scales the random component dominates. The ratio in the last column becomes infinite as the time scale approaches zero which indicates completely random behavior.

Timescale Effects in Relative Channel Capacity: Δt or the time increments of observations

The information relevant at larger Δt arrives relatively slowly when compared to shorter periods. Also there is relatively more time available to process the information at larger Δt time scales. If one were to gradually shrink At the arrival rate of relevant information would generally increase and the time to process that information would decrease. If observations were originally made at the long Δt, where Cp>Cr then gradually the ratio Cr/Cp would climb from Cr/Cp<1, Cr/Cp=1 and finally Cr/Cp>1 at some critical Δt. At Cr/Cp>1 there is a loss of information each second.

Δtlarge>Δtmedium>Δtsmall

(Generally as timescales shrink from very wide to very short, the processing time shrinks while information flow increases, the diffusions are called relative because the relative degree of possible subdiffusion(and thus the other types in the limit is determined by resolution limit/accuracy at each timescale)):

Under Δtlarge, then Cr/Cp<1 there exists a state of relative subdiffusion,

Under Δtmedium, then Cr/Cp≦1 there exists a state of relative normal diffusion,

Under Δtsmall, then Cr/Cp>>1 there exists a state of relative superdiffusion.

Timescale effects in Relative Channel Capacity: T or the time horizon or investment time horizon in finance versus λtime (Lyapunov time) or 1/K(1/Kolmogorov Entropy) time.

Another way that time affects the model is through the time horizon or length of the investment. At the longer timescales when Cp>Cr (Still and and T<λtime (Note λtime maybe realistically infinite) the price series or activity will be more dominated by the deterministic component of behavior. In this region of behavior prediction is possible.

If Cp>Cr but T>λtime (Given that Cp>Cr this λtime is completely determined by the original system uncertainty (which in the smallest limit is quantum uncertainty) and by noise from the environment) then the stochastic component will play an increasingly larger role in the movement of the price as T increases. This growth in the relative strength of stochastic component is due to the increasing corruption of the deterministic signal at increasingly greater time scales by the chaotic propagation of original uncertainty and the entry of environmental noise in the system. This occurs even though Cp>Cr and no information is being lost by the communication systems.

Putting Relative Channel Capacity, Quantum Uncertainty, and Time dependence (Δt and T) together:

1. As Δt↓→Cr/Cp↑ until system crosses Shannon limit where Cr/Cp=1 or Cr=Cp beyond which chaotically propagating errors are generated (λ>0).

2. As Δt↑→Cr/Cp↓, but if Cr>Cp then there are chaotically propagating errors (λ>0), and a prediction time limit determined by λtime or (1/K)time. If T>λtime then prediction is impossible i.e. no information, but if T<λtime then prediction is possible.

3. As Δt↑→Cr/Cp↓, and if Cr<Cp and relative channel capacity is not introducing chaotically propagating errors (λ<0). However Cr resolution/measurement error still present and in the limit equal to chaotically propagated quantum uncertainty. This will generate a maximum possible value of predictive horizon λtimemax. If Δt>λtimemax then prediction is impossible i.e no information, but Δt<λtimemax then prediction possible.

This analysis has an interpretation to (Holliday et al 2 (2005, 2006)) H(Y|X)=−λ(Y|X)

Microscopic Chaos

This paper makes the assumption that the mathematics of microscopic chaos can be used to model the diffusive behavior generated by quantum uncertainty in physical systems and Relative Channel Capacity in agent/decision maker systems. (Note in agent/decision maker systems the lower limit of uncertainty is determined by the quantum uncertainty). This assumption is based on recent work in physics that seeks to explain the underlying mechanisms which cause the observed Brownian motion and diffusions in gases and liquids (and by extension to securities). It is still an open question in fundamental physics whether Brownian motion type diffusions have their origins in microscopic chaos. (Gaspard et. al. 1998) claimed to have demonstrated experimental evidence for microscopic chaos by direct observation of a colloidal particle in a solution. Several authors such as (Dettman and Cohen 2003) and (Cecconi et al 2007) have shown that non-chaotic systems can generate diffusion and even produce results of statistical tests identical to those generated by chaotic simulations.

However, even these critics of the strength of the proposed experimental evidence ultimately lean in the direction of chaotic scattering as the source of diffusions. For instance (Cecconi 2007 et. al., p 2) state “In the effort of interpreting BM (Brownian motion) and nonequilibrium transport in the light of modern dynamical systems theory, it thus comes rather natural to identify in the chaotic character of microscopic dynamics the main candidate for explaining macroscopic transport.”

Also from (Dettman and Cohen 2000, p 1) “ . . . While we believe that Brownian motion (including both the Brownian particle and the solvent) is most likely chaotic, our simulations (show) that no experimental proof of microscopic chaos has been given . . . ”

Additionally (Cecconi 2007 et al) p 2. imply that the non-chaotic models (including their own) are difficult to imagine originating in nature—“non-chaotic models generating diffusion have been proposed . . . (they) seem to be rather artificial . . . Their (non-chaotic models) relevance to statistical mechanics is thus not obvious . . . ” (Please see Appendix for a quick overview of the relevant aspects of Chaos Theory).

Heterogeneous Information

Currently the diffusion of stock price returns is assumed to follow a process similar to colloidal particles (representing a security) diffusing through impacts with the surrounding medium (information events). The solution or surrounding medium is assumed to have uniform temperature (or information density/relative channel capacity). I modify this aspect of the model with what I believe is a more realistic assumption based on financial intuition. I assume that the medium in which the particles diffuse is not homogeneous initially and continues to evolve over time (non-uniformity of solution temperature). Most would agree that information density varies across securities and across time for specific securities. Information density may vary at different times of the day, month, year, or before and after the release of important financial reports etc.

Market Component of Information

Additionally the Brownian model implies that all information is local to the impacted particle. Each particle independently is affected only by the area of the solution in which it finds itself at a particular time. There is no avenue for global (or market wide) impacts of all particles by the same information at the same time. This runs counter to the financial intuition that there are news events such as the release of important macroeconomic news which may simultaneously impact entire markets. I allow for the influence of market wide shocks in this modified Brownian motion framework.

These changes fit more closely the intuition about the behavior of prices and news events. Additionally taken together with microscopic chaotic diffusion the two changes in information behavior naturally generate the diffusive and anomalously diffusive properties that are seen empirically in financial time series. These include periods of high and unexpectedly changing correlation or comovement, and the greater frequency of extreme events than standard theory implies. Finally these changes allow the development of a portfolio optimization technique based on reduction of the anomalous diffusive properties of certain low dimensional chaotic structures.

Three States of price evolution and information density (relative channel capacity) (Sub, Normal, Super Diffusion)

In this Modified Brownian framework price and returns have three different states of behavior and move into and out of these states of price evolution and diffusion through the influence of information density (relative channel capacity). In high information density (relative channel capacity) environments the mean free path or distance that the price can travel before impacting an information event decreases. The price can become trapped or it's movement constrained in a localized region of the diffusive medium (information space). The restriction of movement or trapping of the security leads to behavior that can be described as sub-diffusive. If the security moves into a less dense region or the information density (relative channel capacity) of this region decreases through a drop in the number or magnitude of information events (through the decrease in the number of information events or colloidal particles per unit of volume) the mean free path will increase to the point where normal diffusive behavior is observed. This is condition parallels that assumed in the diffusive metaphors for traditional financial models. Assuming that this normal diffusive condition is static led to the adoption of the normal assumptions that have been challenged by many financial empirical studies. A final third state is reached when the information density(relative channel capacity) drops even further. In this state security prices will have relatively long mean free paths when compared to the other two states. The security price will be able to travel further than expected (by normal models) leading to the greater prevalence of extreme price change events. These three states through which securities move in response to changes in information density (relative channel capacity) parallel the classic period doubling route to chaos through the gradual change a control parameter. (See Appendix)

These changes in information density(relative channel capacity) and the resulting emergence of different states of price evolution occur at different times for different securities. This is analogous to particles in a fluid diffusing through areas of different and changing densities or temperatures in the fluid. The presence of these three states changes the overall distribution of a collection of such securities. The sub-diffusive and super-diffusive elements result in higher central peaks and fatter tails respectively than would be expected from normally diffusing securities. I call this the Mixed Diffusive States Hypothesis.

These facts when seen by traditional stochastic financial modelers helped motivate development of the Mixed Distribution Hypothesis, trading time, and the trading time subordination of Brownian motion. These ideas have been criticized as ad hoc. However each of these ideas are simply the logical result of the simple and intuitive underlying framework presented above. Further additional information, not available to modern stochastic volatility models, can be obtained through an understanding of the micro-structure generating the stochastic effects.

Mixed Distribution Hypothesis:

I suggest that Modified Brownian motion is the source of the behavior that is modeled in stochastic volatility models and the origin of the underlying structure hinted at in the Mixed Distribution Hypothesis. (MDH). Trading time and its evolution in the MDH is the result of the changes in information density(relative channel capacity) in the Modified Brownian motion model. Trading time itself can be thought of as the equivalent of the mean free path. (The modern stochastic volatility models however have no assumptions about the micro structure generating the mixed distributions and therefore cannot exploit any potential additional information provided by that structure and its evolution.

“SV (stochastic volatility) . . . can be viewed as arising from Brownian motion subordinated to a random clock. This clock time, often referred to trading time, may be identified with the volume of trades or the frequency of trading Clark 1973) . . . ” (Gatheral 2006). (Clark 1973)” The different evolution of price series on different days is due to the fact that information is available to traders at a varying rate” p. 137

An example of the additional information that can be gleaned from the underlying structure is the phenomena of Correlated Chaotic Collapse and Chaotic Attenuation described in the next section below.

Global or Market wide information shocks and Correlated Chaotic Collapse and Chaotic Attenuation

There are additional dynamics possible within the three state framework. In this section I will focus on the market component of information density (relative channel capacity). It is assumed that there is always a market wide component, which can be thought of as macroeconomic news or other market affecting events. This additional information generates dynamics from the influence of temporally correlated and uncorrelated market shocks.

Correlated market shocks arise from a simultaneous global increase or decrease in information density (relative channel capacity). The information space retains its heterogeneity but all regions experience the temporary changes in the same direction at the same instant.

Uncorrelated market shocks also change the information density (relative channel capacity) globally but hit each local region at independent times with the same intensity.

Although occurring at different times the average amount of the additional information will be equal over time in different areas of the information space. These correlated and uncorrelated shocks give rise to the phenomena of Correlated Chaotic Collapse and Chaotic Attenuation. (This behavior can be viewed as a “soup” or mixture of groups matter with different phase transition or melting points. As global temperature (information density (relative channel capacity)) changes whole classes or groups shift states simultaneously. Some groups collectively shift into chaotic correlation and collapse and which lead to surprising increases in correlation and comovement.

Others move together into chaotic attenuation the resultant extreme price changes. (Serletis et al. 1999) found evidence of chaotic dynamics in all of the Belview natural gas liquids markets. Additionally the authors report the following counter intuitive observation: “One interesting feature of Belview hydrocarbon prices is the cotemporaneous correlation between these prices.” P. 86. If these markets are truly chaotic and are experiencing exponential separation of nearby orbits how is it possible that they be highly statistically correlated? The concept of Chaotic Synchronization offers a possible explanation (Mosekilde et al. 2002). It has been observed both theoretically and empirically in many different fields that coupled chaotic systems can under certain circumstances become synchronized.

Correlated Chaotic Collapse

I posit that these markets are in essence coupled by global changes in average information density (relative channel capacity) or market shocks. These systems are assumed to be occupying the chaotic diffusive state.

LOGISTIC MAP CHAOTIC DYNAMICS (See Appendix)

Also assume that similar to the logistic system above there is a window of stable orbits between chaotic regions as the control parameter is adjusted. (See Appendix) These systems are theorized to be on the left side of a window in the chaotic region near the window (3.57<r<3.828). These market shocks temporarily push these chaotic systems into the nonchaotic realm (3.828<r<(next chaotic boundary)). In that new state the systems start to collapse exponentially onto the same orbit or periodic solutions. As they fall toward the same solutions (period behaviors) their correlations increase. Because these shocks are temporary in relation to the local information space the increased information density (relative channel capacity) globally subsides restoring the dominance of the local information and a return to normal chaotic diffusion. This process can occur with correlated and surprisingly uncorrelated noise, which only needs to increase the average information density (relative channel capacity) to the point that the systems fall out of the chaotic state and therefore evolve toward the same trajectories. Thus the results of simultaneously chaotic and correlated markets as seen in (Serletis et al. 1999) have an easy explanation in the three state model (Note this phenomena can also explain seemingly counterintuitive results such as securities that are expected to move together or apart in reaction to market news but doing exactly the opposite. For it is not only the direction of the news, but also the diffusive state of the security and the density of the information space that will determine whether correlations occur or not).

Chaotic Attenuation

The other side of the influence of market shocks (once again correlated or uncorrelated) is on pushing systems from the chaotic realm to the super-diffusive region. Once again assume some securities are in a normal diffusive region but instead they occupy a region very far from a stable window compared to the previous case. These securities are collectively hit by global correlated or uncorrelated decreases in information density (relative channel capacity) which leads to super-diffusive behavior.

Portfolio optimization by the detection and control of the degree of chaos, chaotic intermittency, and the predictive horizon of included investments.

The definition the Lyapunov time is (LT) tλ=a(1/λ) (where a is a constant) and the reciprocal of Kolmogorov entropy 1/K. (LT) and 1/K define the “time scale of a rational and effective forecast” (He 2011, p 245). In a chaotically evolving system beyond this limit the initial measurement errors (or the limit of initial precision) grow to dominate estimates of the future state of the system. “Beyond this horizon, several trajectories from nearby initial conditions separated by the initial precision ε(initial) will disperse in the phase space” (Gaspard 2000, p 3). Beyond this point (>(LT) tλ and a(1/λ) is where true classical diffusion occurs. This diffusion (when α=1, in <x2≈tα) is what is assumed in many theories in modern finance such as portfolio theory and the Black-Scholes model.

I add to my previous work the condition that securities or investments selected for a portfolio should first be chaotic or have a positive Lyapunov exponent (∞>>λaverage>0). Additionally, the securities or investments should have a Lyapunov time and/or a reciprocal of Kolmogorov entropy, which are both less than the Portfolio's time horizon. These conditions are added to the exclusion of intermittently chaotic securities introduced earlier. These three conditions are the basis of Normal Gaussian Diffusion which is often assumed in modem financial theory.
Portfolio Time Horizon>tλ and 1/K for selected securities
∞>>λaverage>0 and implies α=1 in <x2≈tα
Exclude intermittently chaotic securities
These conditions are indicative of Normal Gaussian Diffusion assumed in standard Portfolio Theory

(Below I describe the importance of excluding intermittently chaotic securities or investments from a portfolio.)

I propose optimizing a portfolio of securities or investments, by finding and excluding those securities whose behavior can be identified as intermittently chaotic. These securities have a greater probability of experiencing regime change than standard analysis of their historical time series imply. Intermittently chaotic securities can be expected to be more susceptible to anomalous diffusive behavior by the means of Chaotic Collapse or Chaotic Attenuation or a transition from relatively stable behavior to chaotic evolution. It is this unexpected regime change to new behavior that makes these securities unfit for standard historical correlation testing. Only chaotic tests will be able to identify which securities have the underlying structure indicative of chaotic intermittency. After exclusion of these securities the stock portfolio can then be rebalanced using traditional techniques such as those associated with Modern Portfolio Theory.

Information Density (Relative Channel Capacity) and Agent Information Processing Capacity

The Colloidal Particle collision model of Brownian motion represents a system in which the actor/agent represented by the particle is exhibiting complete and perfect information processing. The particle reacts perfectly in the sense that the collisions with the surrounding medium are based on laws of physics, and these laws are the processing rules. A company or other agent will of course have some information processing limit or channel capacity (In the Shannon sense). The relationship between the information processing limit of the company and the information density (relative channel capacity) of the company's environment will determine the diffusive behavior of the company's price.

A particle has no choice or possibility of not colliding with another particle in its path. However a company may misinterpret information or miss important information entirely and thus not react to it. Continuing with the Brownian metaphor the company will move in an incorrect direction or if missed completely even simply pass through the information event without reacting to it . Also the reverse case of a company reacting to false information which does not exist is possible. Therefore there are two classes of errors which may be described as false negatives and false positives (missing existing information and seeing information where none exists). In the discussion that follows I focus on the case of the company missing information which actually exists).

A company's ability to process information may be equal, below or above the arrival rate of that information. If the channel capacity (processing rate) is equal to or above the information arrival rate then the company's diffusive behavior can be modeled as being determined by the (detected/perceived) information density(relative channel capacity) of its environment. However if the channel capacity (processing rate) is lower than the arrival rate of information the relative amount of information processed and the absolute levels of both information density(relative channel capacity) and channel capacity will determine the diffusive dynamics of the system.

Trapping

The first requirement for trapping is that information density (relative channel capacity) must be at theoretical trapping density as modeled earlier in the pure particle system. Secondly the agent's channel capacity must be equal to or greater than the information arrival rate. If the channel capacity is less than the information arrival rate the agent will not see information that exists and not be trapped at this minimum trapping threshold.

Continuum from Trapping, Subdiffusion, Diffusion, SuperDiffusion

Holding information processing capacity constant imagine gradually lowering information density(relative channel capacity). As seen in the previous analysis diffusive behavior will move along the continuum through trapping, subdiffusion, diffusion, and finally to superdiffusion. Now imagine holding information density (relative channel capacity) constant and lowering the recognition rate of information. Gradually the agent will recognize less information and realistically be in information environments of lower and lower density. Equivalently the agents behavior will also progress from trapping, subdiffusion, diffusion, and finally to superdiffusion.

Optimal Decisions and Relative Channel Capacity

An assumption I make is that there is an optimal price response to a given information signal (This is similar to assuming that a diffusing particle future movements are governed by the laws of physics exactly.) In the illustration below the optimal price path of a hypothesized security is given as ABCA . . . A company (and the other actors in the market for the corresponding security) will attempt to appropriately detect, process and act upon arriving information. This processing will inevitably involve communication throughout the company's network and the market of the detected information. There is a limit in terms of bandwidth of the rate of information that can be processed per second. Shannon showed that if the bandwidth of a communications medium is equal to or higher than the communicated signal's information rate that the original signal can be approximated with an arbitrarily small amount of error.

Volatility and Information Processing Capacity

If group of companies occupying similar information density(relative channel capacity) environment those with higher channel capacity will have lower volatility relative to others in the group.

Passive Versus Active Brownian Motion

Extensions to Cell Migration and Animal Foraging

This interplay between information (or resource) density and information processing capacity can be used to explain not only diffusive price behaviors and its presumed anomalies, but also other questions about diffusion in other fields such as cell migration and optimal animal food search patterns (foraging). Additionally this line of research may help to answer (Klages p. 38) question about the appropriateness of using Brownian motion in new contexts given the fact that in “Einstein's theory a Brownian particle is passively driven by collisions from the surrounding particles, whereas biological cells move actively by themselves converting chemical into kinetic energy”.

The same criticism about the appropriateness of a passive versus active description price behavior in response to information may be raised. The price of a security is determined by the interplay of the actions of the company (represented by the price) and other market participants in response to information. A company (or the complete market, including the subject company, that determine a stock price) may be more accurately described by an active Brownian Diffusive model.

A thought experiment might help to elucidate this difference. One could imagine a true normal passively driven Brownian particle replaced by one controlled by physicists. Instead of actually impacting other particles in a surrounding solution, the physicists would be in control the future movement of the controlled particle. They would be tasked with replicating the exact behavior of a true passively driven Brownian particle. The controllers would utilize the appropriate Newtonian collision mechanics as well as make proper detection and analysis of the approaching particles in the hypothesized surrounding solution. Velocities including the angles of incidence and other important data would have to be estimated and then acted upon to send the particle upon the proper path.

Non-Replenishable (Nonrevisitable) Resource Foraging

One could also examine active diffusion in the context of a cell or animal and its possible diffusive evolution using the information (resource) density analysis from above. A foraging animal may initially find itself in a resource rich environment. At this point the animal could consume non-replenishable resources without traveling very far from its point of origin. Gradually the animal would consume the most easily available resources. The density of the desired resource would gradually drop, and the animal would find itself traveling greater distances between resource points (moving along the diffusive continuum form relative trapped toward superdiffusion). At some critical point the density would drop to a level that would trigger the animal to seek out a more resource rich environment (Similar to escaping a local region in a diffusive process). At this point the entire process would start over again. A constrained optimization process to minimize search times, energy expenditure etc. could be modeled in this fashion. Phenomena such as Levy flights, intermittent search strategies and other subdiffusive and superdiffusive activity in the natural world may be viewed interms of relative information (resource) density.

Appendix:

Chaos an Overview:

Chaotic systems are notable for several generally accepted features, which include their sensitivity to initial conditions, bounded evolution, visitations to all places of their phase space. Sensitivity to initial conditions is the most widely known of the characteristics. This is what underlies the popular quote of the “ . . . turbulence of a butterfly's wings being the difference between the formation of a hurricane or a gentle breeze on the other side of the world . . . ”. Ultimately sensitivity to initial conditions in the chaotic refers to the exponential separation of two arbitrarily close points in the phase space of a chaotic system. This means that even if one knew the exact equations of motion of a system without infinitely precise knowledge of the starting conditions long-range prediction would be impossible.

Chaos was originally thought to be a mathematical oddity with no applications in the real world. Newtonian dynamics has ruled much of the scientific world for centuries. At one time not so long ago, many scientists assumed that given enough computational power and the right equations everything in nature could ultimately be modeled and predicted with any desired precision.

Ironically while studying celestial mechanics, one of the areas long thought conquered by Newtonian thought (and of course extended by the work of Einstein), Poincare (1899) discovered the existence of unstable periodic orbits and their possible chaotic effects on the movements of celestial objects. The existence of chaos in many natural systems is a now a well-established fact. In fact NASA has successfully used these chaotic unstable orbits to send probes vast distances utilizing relatively much less fuel than would otherwise be possible in a technique called Chaotic Transport Gaspard (2000).

Lyapunov Exponents (λ)

One key tool in studying the dynamics of chaotic systems is the Lyapunov exponent (LE). They serve to measure the rate of separation of nearby orbits in the phase space of the dynamical system. In order to be chaotic a system must possess at least one positive LE (A system has as many LE's as dimensions). A positive LE means the system has exponentially separating orbits. In contrast a system with all negative LE's will have orbits that collapse resulting in predictable and simple behavior such as a periodic solution.

Routes to Chaos

Period doubling (or bifucations) was the first studied and the easiest route to chaos and was discovered by Walter Ricker and Michael Feigenbaum in 1954. By altering a parameter in the in an iterative map such as the Logistic map seen below the system displays a remarkable collection of varying behaviors. These behaviors range from a single stable solution for low values of r to the completely random appearing at the other end of the continuum. Logistic equation: x2=rx1(1−x1) and iterate xn+1=rx n(1−xn) for 0 x n 1, for 0 r 4 From 1<r<3 the logistic has a stable equilibrium point. At r=3 the map's evolution changes to two periods and doubles so there is now a stable 2 period cycle. As r is increased a four period solution is encountered, then 8, etc. Each next period doubling transition (bifurcation) occurs with increasingly smaller changes in r. As the number of periods double the previous stable solutions do not disappear from the system but become unstable solutions. Finally a threshold is crossed (at approximately r=3.57) where the system moves from a periodic solution to completely aperiodic behavior. At this point there are an infinite number of unstable solutions, which the system wanders through over time (deterministic but realistically unpredictable after a short interval without infinite precision and the exact equations of motion). Interestingly as r is increased further the system will leave the chaotic realm and enter a new phase of periodic motion. This “window” in the vicinity of r=3.828 or 1+sqrt(8) is where the map enters a stable 3 period orbit. Further increases begin another set of bifurcations until the system moves back into the chaotic state for the rest of the range up to r=4.

The Lyapunov exponents of the logistic map can be calculated as:

=1im(N ∞)1/NΣLOG2(R−2RX0)

Intermittency is another route a system can take to arrive in a chaotic state. The control parameter of the system can be initially set so that the system is in a stable periodic orbit such as in the region of the window mentioned above. The control parameter can then be slightly altered. This will cause the system to evolve in a way similar to the stable orbit for a finite period of time. This stable period will then be interrupted by burst in which the behavior becomes erratic, until once again the system enters a relatively stable period and so on. (Arovas 2011). Intermittency can also be viewed from the standpoint of the stability of the chaotic nature of the system. This can be described by the evolution of the variance of the Lyapunov exponents of a dynamical system (Anteneodo 2004). The higher the relative variance of the LE's the less stable the chaotic nature of the system. If the largest LE moves from positive to negative over time the system will move from a chaotic evolution to a nonchaotic one. Similarly the reverse evolution back to chaotic can occur with an LE moving from negative to positive. Additionally a LE near the value 0 represents a system on the border between the chaotic and nonchaotic states. Any instability in the parameters that affect the LE could lead to intermittent behavior. This intermittency described as periodic behavior interrupted at irregular periods by chaotic bursts.

Certain statistical and mathematical tests can be used to detect the presence of chaos, chaotic traits, and intermittent chaos. These include but are not limited to the detection of a positive Lyapunov exponent, fractal attractor/repellor detection and description, embedding dimensional analysis, and analysis of the variance of the Lyapunov exponents over time. These tests can be conducted over the entire time series or over rolling windows to detect changes in any of the observed traits to determine the existence and evolution of these traits. Microscopic Chaos from collisions with circular scatters (Lorentz gas model) The distance that a particle (price) will travel before impacting an element of the surrounding medium (information) is known as the mean free path (L) Wells et al. (1983). This given by the equation below:

L=1/((N/V) (SQRT(2))̂2)

Additionally it can be shown the Lyapunov (λ) exponent came be calculated

λ(V/L)lnL/D

Where N/V is the number of particles per unit volume, and D is the diameter of the spherical elements of the surrounding medium. Standard theory of Brownian motion assumes the density of the medium N/V and that the size or magnitude of the medium's elements is constant.

I propose that the mean free path between collisions be made more variable than in the standard model. As the colloidal particle moves from one region of the information or news space to another through diffusion it enters areas or different information densities. This corresponds to our experience that the volume of information changes over time. Some of these changes seem to have some regularity such as seasonality, daily, monthly fluctuations etc., while others seem random. Additionally one could argue that not all news is of the same importance. These two generalizations of the typical microscopic Brownian model, density changes and variance in the magnitude of relative importance of information can be modeled by changing the average distance between scatters (density) and their average size and/or shape.

### REFERENCES

Andreas Albrecht, Daniel Phillips, Origin of probabilities and their application to the multiverse. arxiv.org/abs/1212.0953v1, December 2012.
Celia Anteneodo, Statistics of finite-time Lyapunov exponents in the Ulam map. PHYSICAL REVIEW E 69, 016207 (2004).
Daniel Arovas. Lecture Notes on Nonlinear Dynamics. Department of Physics, University of California, San Diego, May 26, 2011.
Robert B. Ash. Information Theory. Dover Publications. New York, N.Y. 1965.
Bachelier, Louis, 1900. The Theory of Speculation, PhD Thesis., Gaunthier-Villars.
Cecconi, F., M. Cencini and A. Vulpiani. Transport properties in chaotic and non-chaotic many particle systems Journal of Statistical Mechanics. P12001 (2007).
Clark, Peter K., 1973. A subordinated Stochastic Process Model with Finite Variance for Speculative Prices.
Henry Cohn, Order and Disorder in Energy Minimization Proceedings of the International Congress of Mathematicians, Hyderabad, Aug. 19-27, 2010, Volume IV, pages 2416-2443.
Dettman, C. P., E. G. D. Cohen, Microscopic chaos and diffusion. Journal of Statistical Physics 101, 775-817 (2000).
Lecture Notes University of Illinois at Chicago ECE 534, Fall 2009, Natasha Devroye
Gaspard, P., M. E. Briggs, M. K. Francis, J. V. Sengers, R. W. Gammon, J. R. Dorfman, and R. V. Calabrese, 1998. Experimental Evidence for Microscopic Chaos, Nature 394, 865-868 (27 Aug. 1998).
Gaspard, P., 2000. Chaos, Fractals, and Thermodynamics, Bulletin dela Classe des Sciences del'Academie Royale de Belgique, 6e serie, tome XI (2000) 9-48.
Gaspard, P. Diffusion and the Poincare'-Birkhoff mapping of chaotic systems. Proceedings of the XXIth Solvay Conference on Physics “Dynamical Systems and Irreversibility”, Japan, Nov. 1-5, 1998; Advances in Chemical Physics 122 (2002) 109-127.
Gatheral, Jim, 2006. The volatility surface: a practitioner's guide. John Wiley & Sons, Hoboken, N.J.
He, Ling-Yun. Chaotic Structures in Brent & WTI Crude Oil Markets: Empirical Evidence, International Journal of Economics and Finance Vol. 2, No. 5, October 2011.
Tim Holliday, Peter Glynn, Andrea Goldsmith. Shannon Meets Lyapunov: Connections between Information Theory and Dynamical Systems. Proceedings of the 44th IEEE Conference on Decision and Control, and the European Control Conference 2005 Seville, Spain, Dec. 12-15, 2005.
Tim Holliday, Peter Glynn, Andrea Goldsmith. Capacity of Finite State Channels Based on Lyapunov Exponents of Random Matrices. IEEE Transactions on Information Theory, Vol., 52, No. 8, August 2006.
Sana Inoue and Tetsuro Matsuzawa. Working Memory of Numerals in Chimpanzees. Current Biology Volume 17, Number 23 R1004.
From Deterministic Chaos to Anomalous Diffusion Dr. Rainer Klages http://arxiv.org/abs/0804.3068v3 Reviews of Nonlinear Dynamics and Complexity Volume 3, Heinz Georg Schuster (Editor), ISBN: 978-3-527-40945-7, Wiley-VCH 2010.
Mandelbrot, Benoit B., The Misbehavior of Markets: A Fractal View of Risk, Ruin, and Reward., Basic Books, New York, N.Y.
Derivatives Markets, Robert L. McDonald, Addison Wesley, 2006.
Mosekilde, Erik, Dimitry Postnov, Yuri Maistrenko, 2002. Chaotic Synchronization: Applications to Living Systems, World Scientific Publishing Company Inc, Singapore Poincare, H., 1899. Les Methodes Nouvelles de la Mecanique Celeste Vol. III, Gauthier-Villars, Paris.
Serletis, Apostolos, Periklis Gogas, The North American Natural Gas Liquids Markets are Chaotic. The Energy Journal, Vol. 20, No. 1 (1999).
C. E. Shannon. A Mathematical Theory of Communication. The Bell System Technical Journal, Vol 27, pp. 379-423, 623-656, July, October 1948.
Stachel, John, David C. Cassidy, Jurgen Renn, Robert Schulmann, Don Howard, A. J. Kox, Ann Lehar, 1989. The Collected Papers of Albert Einstein Volume 2 The Swiss Years: Writings, 1900-1909. Princeton University Press, Princeton, N.J. Fundamentals of Wireless Communication, D. Tse and P. Viswanath, Cambridge University Press, 2005.
Wells, Dare A., Harold S. Slusher, 1983. Theory and Problems of Physics for Engineering and Science. McGraw-Hill Publishing Company, New York, N.Y.

The invention claimed is:

1. A method of portfolio management comprising:
receiving at a computer of an investor a portfolio of investments or securities with historical market price data; responsive to the receipt of said portfolio of investments or securities with corresponding historical market price data, said computer conducting tests of indications of the existence and duration of the predictive time horizon on the individual investments or securities; generating the group of investments or securities to include in the new portfolio based upon selecting individual investments or securities from said original portfolio for exclusion or rebalancing in the final portfolio on basis of positive results indicating that the predictive time horizon of the investments or securities exceeds the portfolio time horizon as determined by results of the mathematical and statistical tests for the predictive time horizon of the investments or securities in the historical market price data in the corresponding investment or security.

2. A method of portfolio management comprising:
receiving at a computer server from at least one client system associated with an investor a portfolio of investments or securities with historical market price data; responsive to the receipt of said portfolio of investments or securities with corresponding historical market price data, said computer conducting tests of indications of the existence and duration of the predictive time horizon on the individual investments or securities; generating the group of investments or securities to include in the new portfolio based upon selecting individual investments or securities from said original portfolio for exclusion or rebalancing in the final portfolio on the basis of positive results indicating that the predictive time horizon of the investments or securities exceeds the portfolio time horizon as determined by results of the mathematical and statistical tests for the predictive time horizon of the investments or securities in the historical market price data in the corresponding investment or security.

3. A method of portfolio management comprising:
receiving at a computer of an investor a portfolio of investments or securities with historical market price data; responsive to the receipt of said portfolio of investments or securities with corresponding historical market price data, said computer conducting tests of indications of the existence and duration of the predictive time horizon on the individual investments or securities; generating the group of investments or securities to include in the new portfolio based upon selecting individual investments or securities from said original portfolio for inclusion and/or rebalancing in the final portfolio on basis of positive results indicating that the predictive time horizon of the investments or securities exceeds the portfolio time horizon as determined by results of the mathematical and statistical tests for the predictive time horizon of the investments or securities in the historical market price data in the corresponding investment or security.

4. A method of portfolio management comprising:
receiving at a computer server from at least one client system associated with an investor a portfolio of investments or securities with historical market price data; responsive to the receipt of said portfolio of investments or securities with corresponding historical market price data, said computer conducting tests of indications of the existence and duration of the predictive time horizon on the individual investments or securities; generating the group of investments or securities to include in the new portfolio based upon selecting individual investments or securities from said original portfolio for inclusion and/or rebalancing in the final portfolio on basis of positive results indicating that the predictive time horizon of the investments or securities exceeds the portfolio time horizon as determined by results of the mathematical and statistical tests for the predictive time horizon of the investments or securities in the historical market price data in the corresponding investment or security.
Steps for claims 1 and 2:
1. A subset of but not limited to the above tests for chaos and descriptions of chaotic behavior are conducted on the historical values of the individual securities or investments in a portfolio.
2. Those securities or investments deemed to have a predictive time horizon that exceeds the portfolio time horizon are excluded from or rebalanced in the portfolio.
3. The portfolio can be rebalanced using the traditional techniques of Modern Portfolio Theory.
Steps for claims 3 and 4:
1. A subset of but not limited to the above tests for chaos and descriptions of chaotic behavior are conducted on the historical values of the individual securities or investments in a portfolio.
2. Those securities or investments deemed to have a predictive time horizon that exceeds the portfolio time horizon are included or rebalanced in the portfolio.
3. The portfolio can be rebalanced using the traditional techniques of Modern Portfolio Theory.
